(19) United States
(12) Patent Application Publication
(10) Pub. No.: US 2001/0040312 A1
(43) Pub. Date: Nov. 15, 2001

(54) Process for making a toilet bar containing a transparent decorative top layer

(76) Inventor: John van der Hagen, Leander, TX (US)

Correspondence Address: Rick B. Yeager, 10805 Mellow Lane, Austin, TX, 78759, US

(21) Appl. No.: 09/850,714

(22) Filed: May 7, 2001

Related U.S. Application Data
(63) Continuation-in-part of application No. 09/374,750, filed on Aug. 13, 1999, now abandoned.

(51) Int. Cl. B29C 39/12

(52) U.S. Cl. 264/245; 264/246; 264/255

(57) ABSTRACT

A process for preparing a toilet bar having a decorative colored pattern in a transparent top layer. In one embodiment, the method comprises preparing a first transparent soap composition; pouring the first composition into a mold to partially fill the mold where one to four colored dye mixtures, each composed of a cosmetic dye, glycerin, and water, have been applied to various portions of the bottom and sidewalls of the mold; cooling the first composition; preparing a second soap composition; pouring the second composition into the mold to fill the mold; cooling the second composition; and removing the cooled soap article. In another embodiment, the mold is filled with a single transparent soap composition after the dye is applied to the mold.

### RELATED APPLICATIONS

This application is a Continuation-in-Part of application Ser. No. 09/374,750 filed on Aug. 13, 1999.

### FIELD OF INVENTION

The present invention relates to a process for preparing a decorative article of soap.

### BACKGROUND

The present invention relates to a process for the preparation of soap articles containing a decorative pattern on and in a top layer of clear or colored transparent soap.

Transparent soaps are popular with consumers, and many consumers desire decorative soap articles comprised of transparent soap formulations.

The prior art includes numerous formulations and process for transparent and translucent soaps. U.S. Pat. No. 4,584,126 issued to Joshi on Apr. 22, 1986 provides a background on formulations and manufacturing processes for translucent and transparent soaps.

The prior art also includes transparent soaps with embedded soap shapes, printed films, and other articles. U.S. Pat. No. 5,217,639 issued Jun. 8, 1993 to Mottola describes a dual-phase toilet bar having a first portion that is at least translucent and a second portion that is opaque joined at a curvilinear shaped surface. A process is disclosed wherein a clear composition is poured to partly fill a mold. Thereafter, an opaque composition is poured into the remaining volume of the mold, this composition being essentially identical to the clear composition but also including a small amount of solid particulate opacifying agent. Alternatively, the opaque composition may be poured first into the mold followed by the clear composition.

An object of the present invention is to provide a soap bar having a transparent decorative top layer.

U.S. Pat. No. 4,504,433 issued Mar. 12, 1985 to Inui et al describes a process for the preparation of soap articles containing dried shapes also formed of soap. The process comprises the steps of placing a dried shape of colored soap on a supporting base of transparent soap which has been cooled to solidification but not been dried; and then adding transparent soap, which may or may not be colored; cooling to solidification; and removing the solidified transparent soap; followed by drying the soap.

The present invention provides a unique and aesthetically pleasing transparent toilet bar incorporating a decorative top layer.

### SUMMARY OF THE INVENTION

A two-step molding process is described for preparing a soap toilet bar by preparing a first transparent soap composition; applying one to four dye color mixtures to portions of the bottom and inside walls of a mold cavity; pouring the first transparent composition into the mold to partially fill the mold; cooling the first composition; and filling the mold with either a second composition or the first composition. The mold contents are then cooled, removed, and packaged.

The dye colors partially diffuse into the top layer and overlap in the layer to create a pleasing appearance.

In one embodiment of the current invention, the first portion is transparent and the second portion that is opaque. In another embodiment, both the top and the bottom portions are transparent.

### BRIEF DESCRIPTION OF THE DRAWINGS

The above-mentioned and other objects and features of the present invention will become apparent from a reading of the following detailed description with reference to the accompanying drawings, in which:

FIG. 1 is a cross section of a finished bar.

FIG. 2 is a top view showing a typical application of four dye mixtures to the mold.

FIG. 3 is a cross section view of a partially filled multi-cavity mold.

FIG. 4 is a top view of a finished bar.

### DETAILED DESCRIPTION OF EMBODIMENT

The term “transparent” as used in this specification is intended to connote its usual dictionary definition. A transparent soap allows ready viewing of objects behind it; while a translucent soap will allow light to pass through in a scattered manner that makes difficult to clearly identify objects behind the translucent soap. A practical test for transparency is to place a ¼ inch thick section of the soap article over a printed matter having a bold-faced type of 14 point size. If the print can easily be read, then the bar is considered to be transparent. In the preferred embodiment, transparency or optical clarity is achieved independent of color of the bar.

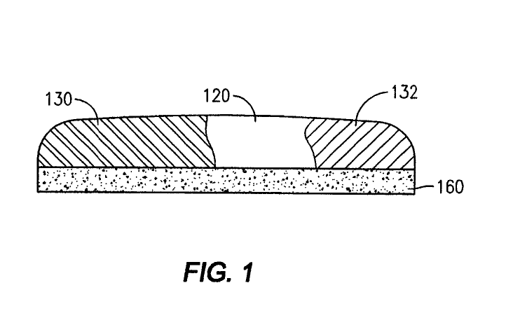

Referring now to FIG. 1, the finished bar consists of a first portion layer 120 and a second portion layer 160. Four dye mixtures were applied to the mold which created the first portion layer, and those dyes, including the first dye 130 and the second dye 132 are partially diffused into the first portion layer.

The preferred embodiment of the invention utilizes a colored transparent soap base of the following approximate composition. All parts, percentages and proportions referred to herein and in the appended claims are by weight unless otherwise indicated:

| | |
|---|---|
| Propylene Glycol | 22% |
| Sorbitol 70% | 13 |
| Sodium Lauryl Ether Sulfate | 10.5 |
| Stearic Acid | 12 |
| Myristic Acid | 5 |
| Glycerine | 12 |
| Water | 11.5 |
| NaOH (50% with Water) | 5 |
| TEA (Triethanolamine) | 1 |
| Sodium Cocoyl Isethionate | 7 |
| Fragrance | 1 |
| Color | |

This soap composition may be clear, or a color may be obtained by the addition of a 1% solution of FD&C Red #40, Red#4, Yellow #5, D&C Red #33, or other Food, Drug, and Cosmetic or Drug & Cosmetic colors in 50% propylene glycol and deionized water. Optionally, a relatively small amount of glitter may be added to the formulation for additional decorative effect.

The transparent soap formulation is prepared in a 1000 pound batch by mixing the Propylene Glycol, Sorbitol 70%, and Sodium Lauryl Ether Sulfate at a temperature in the range of 155-170° F., preferably at 160° F.; and then continuing to add the Stearic Acid, Myristic Acid, Glycerine, and water while maintaining the temperature at 160° F.; adding the 50% NaOH solution, which will cause the temperature to rise approximately 10 to 15° F.; and then continuing to add the remaining ingredients. The final temperature will typically be in the range of 155 to 160° F.

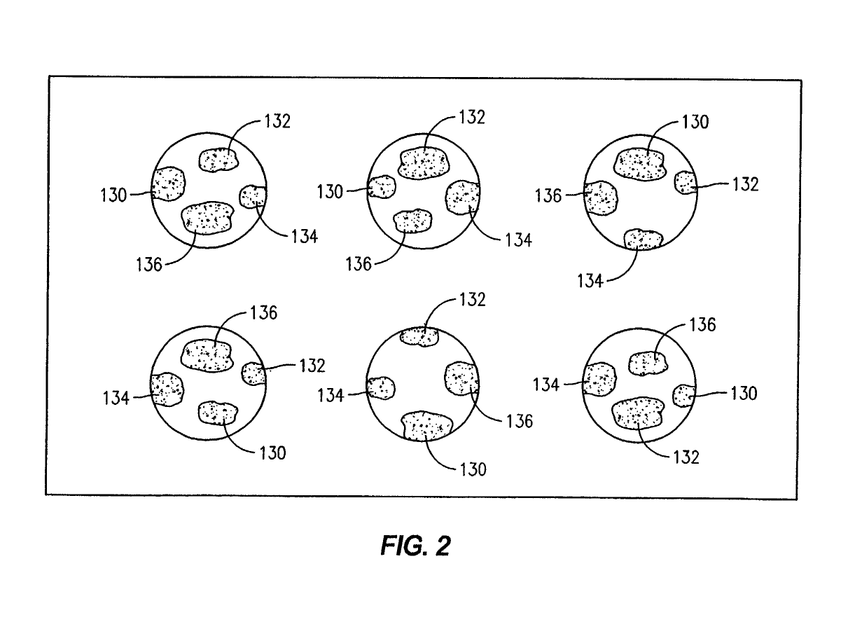

Referring now to FIG. 2, a method of manufacture of the decorative article is to apply each of the dye mixtures to a portion of the bottom and a portion of the adjacent mold wall. In this example, 4 colors of dye are used 130, 132, 134, and 136. The colors of blue, red, orange, and yellow are obtained by mixing a food or cosmetic dye water and propylene glycol. The color is typically applied by spraying, brushing, or dropping a few drops of solution onto the mold surface. The dye mixtures may be sprayed or applied by hand, typically with a cotton swab, or similar applicator. A simple design is preferable so that 6 designs can be painted in approximately 40 seconds on a production line.

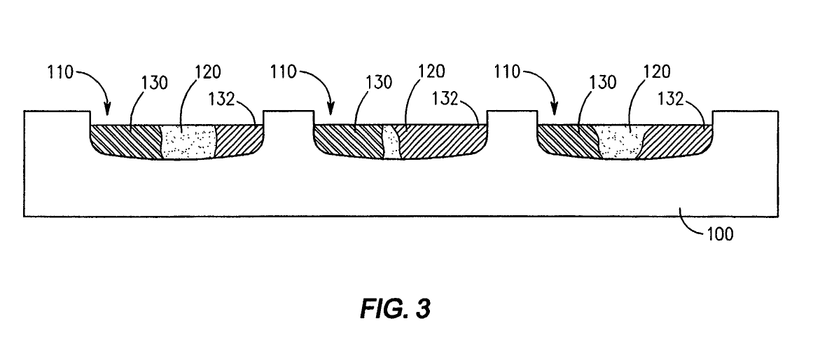

Referring now to FIG. 3, the first composition 120 is poured into a multi-cavity bar silicone release mold 100 until the mold cavities 110 are approximately 40-70% filled. Each cavity is in the shape of the finished article of soap. Typically, a six-cavity silicone release mold will be used for a bar of soap of approximately 3 to 4 inches diameter and approximately ¾ inch thick. These release molds are commercially available. The manufacture is typically performed on a conveyor production line. As the partially filled molds move down the line, cooling takes place and the partial bars begin to solidify. The cooling is typically enhanced in a coolant chamber maintained at approximately 34° F. The partially filled mold is cooled until the soap composition reaches a temperature of approximately 77 to 82° F., which typically requires approximately 30 minutes of cooling.

After cooling of the first layer, the partially filled molds are typically directed to a second fill operation where the second molten soap composition is applied to fill the remainder of the soap cavities. This second molten soap composition is typically white, but may be transparent, translucent, or various opaque colors. In this example, the second soap composition is following approximate composition to provide a white soap. Alternatively, other coloring agents may be added. All parts, percentages and proportions referred to herein and in the appended claims are by weight unless otherwise indicated:

| | |
|---|---|
| Propylene Glycol | 21.5% |
| Sorbitol 70% | 13 |
| Sodium Lauryl Ether Sulfate | 10.5 |
| Stearic Acid | 12 |
| Myristic Acid | 5 |
| Glycerine | 12 |
| Water | 11.5 |
| NaOH (50% with Water) | 5 |
| TEA (Triethanolamine) | 1 |
| Sodium Cocoyl Isethionate | 7 |
| Fragrance | 1 |
| Titanium Dioxide | 0.5 |

The second soap composition is melted at a temperature of approximately 160° F. and poured into a cavity 110 of a silicon mold to essentially fill the mold cavity.

The full soap cavity molds are cooled on the production line, removed from the mold and wrapped or packaged for sale.

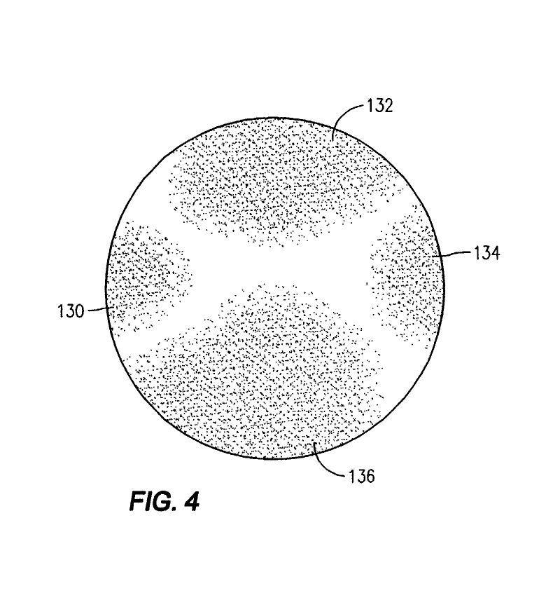

Referring now to FIG. 4, which is a top view of a representative bar, the effect of this manufacturing process is to produce a two layer soap article having a tie-dye effect with the various colors 130, 132, 134, 136 diffused into the transparent layer.

The cross section article is not limited to an circular shape, and may be of a rectangular, polygonal, oval, or other shape that is useful for a soap article.

It is generally desirable to use diluted dye mixtures to minimize excessive color bleed and transfer of color from the soap bar to the hands of the user.

Referring again to FIG. 1, the finished bar consists of the first transparent portion layer 120, the second opaque portion layer 160, with a decorative color pattern 130 and 132. The decorative color pattern is achieved by the irregular dispersion of the dye mixture across and within the first layer as it is added to the mold containing the color dyes.

In this embodiment, the second composition is similar in formula to the corresponding transparent composition, except for the addition of an opaque dye. In alternative embodiments, the second composition may be a second color or include decorative elements such as a pearlescent additive.

Various modifications of the formula and process will be apparent to one skilled in the art.

In alternative embodiments the soap article may be prepared directly in product packaging such as blister packs or clamshell packages.

Description of Alternate Embodiment—Colored Soap Base

In an alternate embodiment, two or more dye colors are applied to the mold cavity as described above. The mold is then partially filled with the first soap composition. A yellow first soap composition provides interesting areas of diffusion from the dyes. For instance, referring to FIG. 1, a yellow transparent soap may be used as the first soap composition 120 may be used in combination with a blue dye and a red dye. The blue dye 130 produces areas of blue from the dominance of the dye, green from a mixture of the yellow and the blue, and yellow from the dominance of the base composition. Similarly, a red dye 132 produces areas of red from the dominance of the dye, orange from a mixture of the yellow and the red, and yellow from the dominance of the base composition. There can also be an area of overlap between the red and blue dyes which produces a violet area.

Description of Alternate Embodiment—Color Combinations

The first embodiment described the use of 4 colors—blue, red, orange, and yellow. In other embodiments, other combinations of color may be used. For instance a blue dye and a yellow dye in a clear soap will produce areas of yellow, blue, and green. A 3-color combination of red, blue, and yellow dyes in a clear soap will produce areas of yellow, blue, green, orange, and red.

Description of Alternate Embodiment—Single Fill Composition

The first embodiment describes a two-layer soap article where an opaque layer is poured on top of the transparent layer. In that case, the opaque layer provides a white or colored background when viewing the bar. An alternative embodiment is to apply two or more dye colors to the mold cavity as described in the first embodiment. The mold may then be filled with the first soap composition. The first soap composition may be clear, but is preferably colored. Yellow is an effective soap composition color because it combines well with the blue and red dyes.

What is claimed is:

1. A process for the preparation of a soap article containing at least one partially diffused dye, the process comprising:
providing a molten first transparent soap composition;
applying at least one color dye mixture to a portion of a mold cavity;
pouring the molten first transparent soap composition into soap article mold to partially fill the mold to a depth of approximately 30-70% of the total mold depth, such that the dye is partially diffused into the first transparent soap composition;
cooling the first transparent soap composition;
providing a second soap composition;
pouring the second soap composition into the mold to essentially fill the mold;
cooling the soap article to solidify the first and second compositions; and
removing the cooled soap article.

2. The process of claim 1 wherein applying at least one color dye mixture to a portion of a mold cavity is comprised of
applying two colored dye mixtures to portions of the mold cavity.

3. The process of claim 1 wherein applying at least one color dye mixture to a portion of a mold cavity comprises
applying three colored dye mixtures to portions of the mold cavity.

4. The process of claim 1 wherein applying at least one color dye mixture to a portion of a mold cavity comprises
applying four colored dye mixtures to portions of the mold cavity.

5. The process of claim 1 wherein applying at least one color dye mixture to a portion of a mold cavity comprises
applying the dye mixture to a portion of the bottom of the mold cavity and to a portion of the side wall of the mold cavity.

6. The process of claim 1 wherein providing a second soap composition comprises
providing an opaque soap composition as the second soap composition.

7. The process of claim 1 wherein providing a first transparent soap composition comprises
providing a colored transparent soap composition.

8. The process of claim 1 further comprising
providing a glittering agent in the first transparent soap composition.

9. A process for the preparation of a soap article containing at least one partially diffused dye, the process comprising:
providing a molten transparent soap composition;
applying at least one color dye mixture to a portion of a mold cavity;
pouring the molten first transparent soap composition into soap article mold to fill the mold, such that the dye is partially diffused into the transparent soap composition;
cooling the soap article to solidify the transparent soap composition; and
removing the cooled soap article.

10. The process of claim 9 wherein applying at least one color dye mixture to a portion of a mold cavity is comprised of
applying two colored dye mixtures to portions of the mold cavity.

11. The process of claim 9 wherein applying at least one color dye mixture to a portion of a mold cavity comprises
applying three colored dye mixtures to portions of the mold cavity.

12. The process of claim 9 wherein applying at least one color dye mixture to a portion of a mold cavity comprises
applying four colored dye mixtures to portions of the mold cavity.

13. The process of claim 9 wherein applying at least one color dye mixture to a portion of a mold cavity comprises
applying the dye mixture to a portion of the bottom of the mold cavity and to a portion of the side wall of the mold cavity.

14. The process of claim 9 wherein providing a transparent soap composition comprises
providing a colored transparent soap composition.

15. The process of claim 1 further comprising
providing a glittering agent in the transparent soap composition.

16. A process for the preparation of a soap article containing three diffused dyes, the process comprising:
providing a first transparent soap composition;
applying a first color dye mixture to a first portion of a mold cavity;
applying a second color dye mixture to a second portion of a mold cavity;
applying a third color dye mixture to a third portion of a mold cavity;
pouring a molten first transparent soap composition into soap article mold to partially fill the mold to a depth of approximately 30-70% of the total mold depth, such that the first color dye, the second color dye, and the third color dye are partially diffused into the first transparent soap composition, and such that the first color dye mixture is partially diffused into the second color dye mixture and the third color dye mixture;
cooling the first transparent soap composition;
providing a second soap composition;
pouring the second soap composition into the mold to essentially fill the mold;
cooling the soap article to solidify the first and second compositions; and
removing the cooled soap article.

17. The process of claim 16 wherein providing a first transparent soap composition comprises
providing a colored transparent soap composition.

18. The process of claim 16 wherein applying a third color dye mixture to a third portion of a mold cavity comprises
partially overlapping the first portion of the mold cavity with the third color dye mixture.
